(19) United States
(12) Patent Application Publication
(10) Pub. No.: US 2009/0304379 A1
(43) Pub. Date: Dec. 10, 2009

(54) OPTICAL SIGNAL BIT RATE ADJUSTER, AN OPTICAL SIGNAL GENERATOR, AN OPTICAL TEST DEVICE, AN OPTICAL SIGNAL BIT RATE ADJUSTMENT METHOD, A PROGRAM, AND A RECORDING MEDIUM

(75) Inventors: Masaichi HASHIMOTO, Miyagi (JP); Takao SAKURAI, Miyagi (JP)

Correspondence Address: GREENBLUM & BERNSTEIN, P.L.C., 1950 ROLAND CLARKE PLACE, RESTON, VA, 20191, US

(73) Assignee: ADVANTEST Corporation, Tokyo (JP)

(21) Appl. No.: 12/471,808

(22) Filed: May 26, 2009

(30) Foreign Application Priority Data
May 30, 2008 (JP) 2008-142097

(51) Int. Cl. H04B 10/08

(52) U.S. Cl. 398/16

(57) ABSTRACT

An optical signal bit rate adjustment device of the present invention includes a demultiplexing unit that demultiplexes light into first demultiplexed light and second demultiplexed light, a first optical path through which the first demultiplexed light passes, a second optical path through which the second demultiplexed light passes, a multiplexing unit that multiplexes the first demultiplexed light having passed the first optical path and the second demultiplexed light having passed the second optical path, multiple first period changing units that are disposed along the first optical path, and change a period for which the first demultiplexed light passes through the first optical path according to first electric pulse signals to be fed, and multiple second period changing units that are disposed along the second optical path, and change a period for which the second demultiplexed light passes through the second optical path according to second electric pulse signals to be fed, where the first electric pulse signals and the second electric pulse signals are displaced in timing.

### BACKGROUND ART

1. Field of the Invention

The present invention relates to generation of an optical test signal.

2. Description of the Prior Art

There has conventionally been known that an optical test signal is fed to a DUT (device under test) which inputs/outputs light (refer to Abstract of Patent Document 1).

It should be noted that Non-Patent Document 1 describes conversion of an optical signal from a form of the RZ signal to a form of the NRZ signal, and conversion of an optical signal from a form of the NRZ signal and a form of the RZ signal, and Non-Patent Document 2 describes conversion of an optical signal from a form of the RZ signal to a form of the NRZ signal.

(Patent Document 1) Japanese Laid-Open Patent Publication (Kokai) No. H6-50845

(Non-Patent Document 1) Lei Xu, Bing C. Wang, Varghese Baby, Ivan Glesk, and Paul R. Prucnal, “All-Optical Data Format Conversion Between RZ and NRZ Based on a Mach-Zehnder Interferometric Wavelength Converter”, IEEE PHOTONICS TECHNOLOGY LETTERS VOL. 15, NO. 2, pp. 308-310, February 2003

(Non-Patent Document 2) Yu Yu, Xinliang Zhang, Dexiu Huang, Lijun Li, and Wei Fu, “20-Gb/s All-Optical Format Conversions From RZ Signals With Different Duty Cycles to NRZ Signals”, IEEE PHOTONICS TECHNOLOGY LETTERS, VOL. 19, NO. 14, pp. 1027-1029, Jul. 15, 2007

### SUMMARY OF THE INVENTION

A DUT which inputs/outputs light can be a VLSI which inputs/outputs light, for example, and it is desirable to generate an optical test signal at a higher frequency.

It is an object of the present invention to generate an optical test signal at a higher frequency.

According to the present invention, an optical signal bit rate adjustment device includes: a demultiplexing unit that demultiplexes a light into a first demultiplexed light and a second demultiplexed light; a first optical path through which the first demultiplexed light passes; a second optical path through which the second demultiplexed light passes; a multiplexing unit that multiplexes the first demultiplexed light which has passed the first optical path and the second demultiplexed light which has passed the second optical path; a plurality of first period changing units that are disposed along the first optical path, and change a period for which the first demultiplexed light passes through the first optical path according to first electric pulse signals to be fed; and a plurality of second period changing units that are disposed along the second optical path, and change a period for which the second demultiplexed light passes through the second optical path according to second electric pulse signals to be fed, wherein: the first electric pulse signals and the second electric pulse signals have a common pulse width PW; the number of the plurality of first period changing units is N1, where N1 is an integer equal to or more than two; the number of the plurality of second period changing units is N2, where N2 is an integer equal to or more than two; N=N1+N2; X(n) is a coordinate on an axis of the first period changing unit and the second period changing unit in a direction of the first optical path, where n is an integer equal to or more than one and equal to or less than N, and becomes smaller as a projection on the axis of the first period changing unit and the second period changing unit approaches a projection on the axis of an incident end of the first optical path to which the first demultiplexed light is made incident; for n equal to or more than two, the first electric pulse signal fed to the first period changing unit at a coordinate X(n) and the second electric pulse signal fed to the second period changing unit at the coordinate X(n) correspond to the first electric pulse signal or the second electric pulse signal fed to the first period changing unit or the second period changing unit at a coordinate X(1) delayed by:

(m/N+k)·PW+(X(n)−X(1))nₒ/C

where nₒ is the effective refractive index of the first optical path and the second optical path, C is the velocity of light, k is an arbitrary integer, and m is an integer equal to or more than one and equal to or less than N−1; and m takes different values respectively for the first period changing units and the second period changing units.

According to the thus constructed optical signal bit rate adjustment device, a demultiplexing unit demultiplexes a light into a first demultiplexed light and a second demultiplexed light. The first demultiplexed light passes through a first optical path. The second demultiplexed light passes through a second optical path. A multiplexing unit multiplexes the first demultiplexed light which has passed the first optical path and the second demultiplexed light which has passed the second optical path. A plurality of first period changing units are disposed along the first optical path, and change a period for which the first demultiplexed light passes through the first optical path according to first electric pulse signals to be fed. A plurality of second period changing units are disposed along the second optical path, and change a period for which the second demultiplexed light passes through the second optical path according to second electric pulse signals to be fed.

The first electric pulse signals and the second electric pulse signals have a common pulse width PW. The number of the plurality of first period changing units is N1, where N1 is an integer equal to or more than two. The number of the plurality of second period changing units is N2, where N2 is an integer equal to or more than two. Here, N=N1+N2. X(n) is a coordinate on an axis of the first period changing unit and the second period changing unit in a direction of the first optical path, where n is an integer equal to or more than one and equal to or less than N, and becomes smaller as a projection on the axis of the first period changing unit and the second period changing unit approaches a projection on the axis of an incident end of the first optical path to which the first demultiplexed light is made incident. For n equal to or more than two, the first electric pulse signal fed to the first period changing unit at a coordinate X(n) and the second electric pulse signal fed to the second period changing unit at the coordinate X(n) correspond to the first electric pulse signal or the second electric pulse signal fed to the first period changing unit or the second period changing unit at a coordinate X(1) delayed by:

(m/N+k)·PW+(X(n)−X(1))nₒ/C

where nₒ is the effective refractive index of the first optical path and the second optical path, C is the velocity of light, k is an arbitrary integer, and m is an integer equal to or more than one and equal to or less than N−1.
m takes different values respectively for the first period changing units and the second period changing units.

According to the optical signal bit rate adjustment device of the present invention, as n decreases, m decreases.

According to the optical signal bit rate adjustment device of the present invention, the first period changing unit changes the refraction index at a predetermined portion of the first optical path according to the voltage of the first electric pulse signal to be fed; and the second period changing unit changes the refraction index at a predetermined portion of the second optical path according to the voltage of the second electric pulse signal to be fed.

According to the optical signal bit rate adjustment device of the present invention, the first period changing unit changes the phase of the first demultiplexed light by π when the first electric pulse signal is in a predetermined state; and the second period changing unit changes the phase of the second demultiplexed light by π when the second electric pulse signal is in a predetermined state.

According to the present invention, the optical signal bit rate adjustment device includes a delay unit that delays either one of or both of the first demultiplexed light and the second demultiplexed light so as to maximize or minimize an output of the multiplexing unit when the first electric pulse signals and the second electric pulse signals are not fed.

According to the present invention, an optical signal generation device includes: the optical signal bit rate adjustment device according to the present invention; and a continuous wave light source that supplies the demultiplexing unit with continuous wave light.

According to the present invention, the optical signal generation device may include an output pulse light adjustment unit that adjusts a height or an offset of an output pulse light output by the multiplexing unit.

According to the present invention, an optical signal generation device includes: the optical signal bit rate adjustment device of the present invention, and a pulse light source that supplies the demultiplexing unit with input pulse light.

According to the present invention, the optical signal generation device may include: an NRZ conversion unit that converts output pulse light output by the multiplexing unit into NRZ-signal pulse light; and an NRZ pulse light adjustment unit that adjusts a height or an offset of the NRZ-signal pulse light.

According to the present invention, an optical test device includes: the optical signal generation device of the present invention, and an electric pulse signal source that generates the first electric pulse signal and the second electric pulse signal, wherein an output of the optical signal generation device is fed to a device under test.

According to the present invention, an optical signal bit rate adjustment method in an optical signal bit rate adjustment device which includes a demultiplexing unit that demultiplexes a light into a first demultiplexed light and a second demultiplexed light, a first optical path through which the first demultiplexed light passes, a second optical path through which the second demultiplexed light passes, and a multiplexing unit which multiplexes the first demultiplexed light which has passed the first optical path and the second demultiplexed light which has passed the second optical path, includes: a step of causing a plurality of first period changing units that are disposed along the first optical path to change a period for which the first demultiplexed light passes through the first optical path according to a first electric pulse signal to be fed; and a step of causing a plurality of second period changing units that are disposed along the second optical path to change a period for which the second demultiplexed light passes through the second optical path according to a second electric pulse signal to be fed, wherein: the first electric pulse signals and the second electric pulse signals have a common pulse width PW; the number of the plurality of first period changing units is N1, where N1 is an integer equal to or more than two; the number of the plurality of second period changing units is N2, where N2 is an integer equal to or more than two; N=N1+N2; X(n) is a coordinate on an axis of the first period changing unit and the second period changing unit in a direction of the first optical path, where n is an integer equal to or more than one and equal to or less than N, and becomes smaller as a projection on the axis of the first period changing unit and the second period changing unit approaches a projection on the axis of an incident end of the first optical path to which the first demultiplexed light is made incident, for n equal to or more than two, the first electric pulse signal fed to the first period changing unit at a coordinate X(n) and the second electric pulse signal fed to the second period changing unit at the coordinate X(n) correspond to the first electric pulse signal or the second electric pulse signal fed to the first period changing unit or the second period changing unit at a coordinate X(1) delayed by:

(m/N+k)·PW+(X(n)−X(1))nₒ/C

where nₒ is the effective refractive index of the first optical path and the second optical path, C is the velocity of light, k is an arbitrary integer, and m is an integer equal to more than one and equal to or less than N−1; and m takes different values respectively for the first period changing units and the second period changing units.

According to the present invention, a program causes a computer to execute electric pulse signal generation control processing for controlling the electric pulse signal source of the optical test device of the present invention, thereby generating the first electric pulse signal and the second electric pulse signal.

According to the present invention, a computer-readable recording medium recording a program causes a computer to execute electric pulse signal generation control processing for controlling the electric pulse signal source of the optical test device of the present invention, thereby generating the first electric pulse signal and the second electric pulse signal.

### BRIEF DESCRIPTION OF THE DRAWINGS

FIG. 1 is a block diagram showing a configuration of an optical test device 1 according to a first embodiment of the present invention;

FIG. 2 is a plan view of the optical signal bit rate adjustment device 24;

FIG. 3 describes coordinates of the first period changing units 240a and 240b, and the second period changing units 242a and 242b;

FIG. 4 shows waveforms of the first electric pulse signals CH1 and CH3, the second electric pulse signals CH2 and CH4, and the output pulse light when X(n)−X(1)=0 (n=2, 3, 4), and k=0;

FIG. 5 is a block diagram showing the configuration of the optical test device 1 according to the second embodiment of the present invention;

FIG. 6 shows a configuration in which, to the first embodiment, an electric pulse signal generation control unit 30 which controls the driver module 10 of the optical test device 1 according to the first embodiment is added;

FIG. 7 shows a configuration in which, to the second embodiment, the electric pulse signal generation control unit 30 which controls the driver module 10 of the optical test device 1 according to the second embodiment is added;

FIG. 8 shows an example of the waveform of the output pulse light;

FIG. 9 shows waveforms of the first electric pulse signals CH1 and CH3, the second electric pulse signals CH2 and CH4, and the output pulse light in this variation (when n=2, m=3, when n=3, m=2, and when n=4, m=1);

FIG. 10 shows waveforms of the first electric pulse signals CH1 and CH3, the second electric pulse signals CH2 and CH4, and the output pulse light in this variation (when n=2, k=1, and when n=3 and 4, k=0); and

FIG. 11 shows waveforms of the first electric pulse signals CH1 and CH3, the second electric pulse signals CH2 and CH4, and the output pulse light when X(n)−X(1)=0 (n=2, 3, 4), and k=0 according to the second embodiment.

### BEST MODE FOR CARRYING OUT THE INVENTION

A description will now be given of embodiments of the present invention with reference to drawings.

### First Embodiment

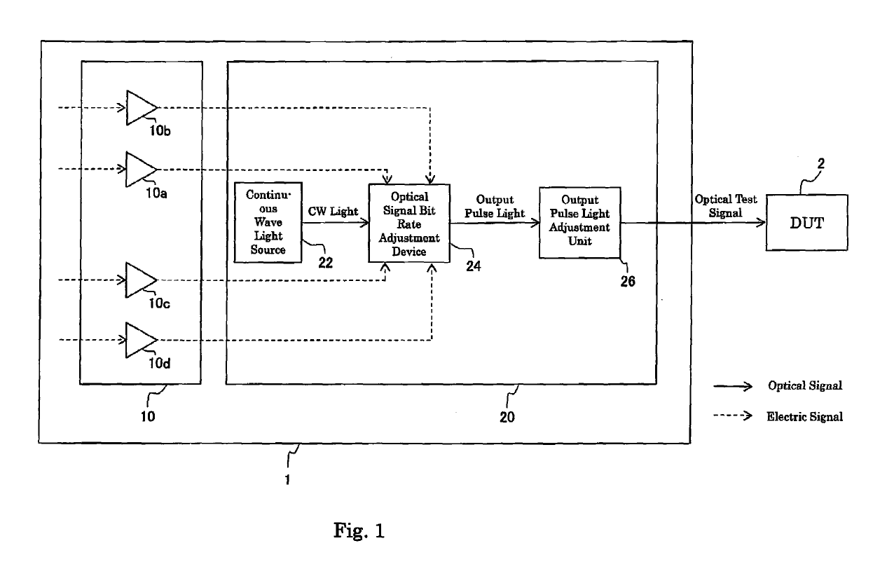

FIG. 1 is a block diagram showing a configuration of an optical test device 1 according to a first embodiment of the present invention. The optical test device 1 includes a driver module (electric pulse signal source) 10 and an optical signal generation device 20. It should be noted that an output (optical test signal) of the optical signal generation device 20 is fed to a device under test (DUT) 2. It should be noted that, the DUT 2 is a VLSI (referred to as optical VLSI) which receives an input of light and outputs light, for example.

The driver module (electric pulse signal source) 10 generates first electric pulse signals and second electric pulse signals. The driver module 10 includes drivers 10a, 10b, 10c and 10d. The drivers 10a, 10b, 10c and 10d receive an electric pulse at a predetermined frequency (such as 5 Gbps), thereby generating first electric pulse signals and the second electric pulse signals. In other words, the drivers 10a and 10b generate the first electric pulse signals, and the drivers 10c and 10d generate the second electric pulse signals. The first electric pulse signals and the second electric pulse signals generated by the drivers 10a, 10b, 10c and 10d have a common pulse width PW and the same phase. Moreover, the pulse width PW is the reciprocal of the bit rate BR (such as 5 Gbps) of the first electric pulse signals and the second electric pulse signals.

It should be noted that the first electric pulse signal generated by the driver 10b and the second electric pulse signals generated by the drivers 10c and 10d are delayed by the optical signal generation device 20 as described later.

The optical signal generation device 20 includes a continuous wave light source 22, an optical signal bit rate adjustment device 24, and an output pulse light adjustment unit 26.

The continuous wave light source 22 feeds continuous wave light (CW light) to the optical signal bit rate adjustment device 24.

The optical signal bit rate adjustment device 24 outputs an optical signal (output pulse light) with a bit rate which is a product of the bit rate BR of the first electric pulse signals and the second electric pulse signals and the number of the first electric pulse signals and the second electric pulse signals. According to the first embodiment, the optical signal bit rate adjustment device 24 outputs an output pulse light with a bit rate of 5 Gbps×4=20 Gbps.

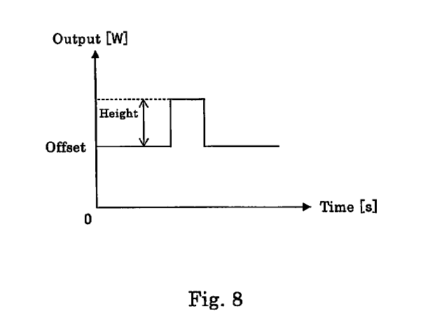

The output pulse light adjustment unit 26 adjusts a height or an offset of the output pulse light output by the optical signal bit rate adjustment device 24, thereby outputting an optical test signal. FIG. 8 shows an example of the waveform of the output pulse light. The height of the output pulse light implies a difference between the highest output and the lowest output of the output pulse light. The offset of the output pulse light implies the lowest output value of the output pulse light. The height of the output pulse light can be adjusted by an attenuator, for example. The height and the offset of the output pulse light can be adjusted by multiplexing the output pulse light attenuated by an attenuator and the CW light the phase of which is properly changed, for example.

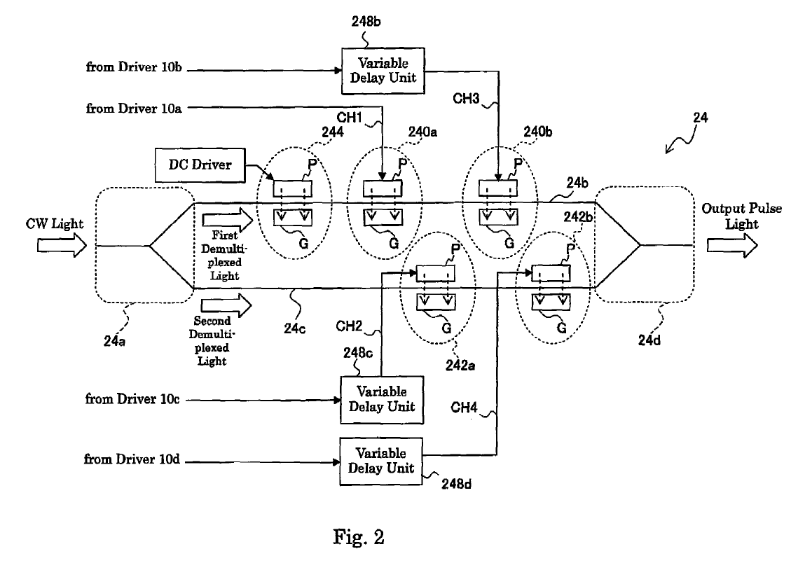

FIG. 2 is a plan view of the optical signal bit rate adjustment device 24. The optical signal bit rate adjustment device 24 includes a demultiplexing unit 24a, a first optical path 24b, a second optical path 24c, a multiplexing unit 24d, first period changing units 240a and 240b, second period changing units 242a and 242b, a delay unit 244, and variable delay units 248b, 248c and 248d. The components of the optical signal bit rate adjustment device 24 are formed on a substrate (such as a substrate made of LiNbO₃ crystal). It should be noted that the substrate is not illustrated.

The CW light is fed from the continuous wave light source 22 to the demultiplexing unit 24a. The demultiplexing unit 24a demultiplexes the CW light into first demultiplexed light and second demultiplexed light.

The first demultiplexed light passes through the first optical path 24b. The second demultiplexed light passes through the second optical path 24c. The first optical path 24b and the second optical path 24c preferably have straight shapes with the same length, and also are parallel with each other. Moreover, the first optical path 24b and the second optical path 24c have the same effective refractive index of a value nₒ.

The multiplexing unit 24d multiplexes the first demultiplexed light having passed the first optical path 24b and the second demultiplexed light having passed the second optical path 24c, and outputs multiplexed light. The output of the multiplexing unit 24d is referred to as output pulse light. The output pulse light is fed to the output pulse light adjustment unit 26.

The multiple first period changing units 240a and 240b are disposed along the first optical path 24b. The first period changing unit 240a includes a positive electrode P and a negative electrode G. The positive electrode P is connected to the driver 10a. The negative electrode G is grounded.

The first period changing unit 240a generates an electric field from the positive electrode P to the negative electrode G. The magnitude of the electric field corresponds to the voltage of a first electric pulse signal CH1 fed from the driver 10a to the first period changing unit 240a. The refraction index of a portion (predetermined portion) of the first optical path 24b between the positive electrode P and the negative electrode G changes according to the electric field generated by the first period changing unit 240a. In other words, the change in the refraction index corresponds to the voltage of the first electric pulse signal CH1 fed from the driver 10a to the first period changing unit 240a. A period for which the first demultiplexed light passes the first optical path 24b changes according to the change in the refraction index.

It is assumed that the first period changing unit 240a changes the phase of the first demultiplexed light by π when the first electric pulse signal CH1 fed from the driver 10a to the first period changing unit 240a is in a predetermined state (when the voltage of the pulse is at a “High” level, for example).

The first period changing unit 240b includes the positive electrode P and the negative electrode G. The positive electrode P is connected via the variable delay unit 248b to the driver 10b. The negative electrode G is grounded.

The first period changing unit 240b generates an electric field from the positive electrode P to the negative electrode G. The magnitude of the electric field corresponds to the voltage of a first electric pulse signal CH3 fed from the driver 10b via the variable delay unit 248b to the first period changing unit 240b. The refraction index of a portion (predetermined portion) of the first optical path 24b between the positive electrode P and the negative electrode G changes according to the electric field generated by the first period changing unit 240b. In other words, the change in the refraction index corresponds to the voltage of the first electric pulse signal CH3 fed from the driver 10b via the variable delay unit 248b to the first period changing unit 240b. A period for which the first demultiplexed light passes the first optical path 24b changes according to the change in the refraction index.

It is assumed that the first period changing unit 240b changes the phase of the first demultiplexed light by π when the first electric pulse signal CH3 fed from the driver 10b via the variable delay unit 248b to the first period changing unit 240b is in a predetermined state (when the voltage of the pulse is at the “High” level, for example).

The multiple second period changing units 242a and 242b are disposed along the second optical path 24c. The second period changing unit 242a includes the positive electrode P and the negative electrode G. The positive electrode P is connected via the variable delay unit 248c to the driver 10c. The negative electrode G is grounded.

The second period changing unit 242a generates an electric field from the positive electrode P to the negative electrode G. The magnitude of the electric field corresponds to the voltage of a second electric pulse signal CH2 fed from the driver 10c via the variable delay unit 248c to the second period changing unit 242a. The refraction index of a portion (predetermined portion) of the second optical path 24c between the positive electrode P and the negative electrode G changes according to the electric field generated by the second period changing unit 242a. In other words, the change in the refraction index corresponds to the voltage of the second electric pulse signal CH2 fed from the driver 10c via the variable delay unit 248c to the second period changing unit 242a. A period for which the second demultiplexed light passes the second optical path 24c changes according to the change in the refraction index.

It is assumed that the second period changing unit 242a changes the phase of the second demultiplexed light by π when the second electric pulse signal CH2 fed from the driver 10c via the variable delay unit 248c to the second period changing unit 242a is in a predetermined state (when the voltage of the pulse is at the “High” level, for example).

The second period changing unit 242b includes the positive electrode P and the negative electrode G. The positive electrode P is connected via the variable delay unit 248d to the driver 10d. The negative electrode G is grounded.

The second period changing unit 242b generates an electric field from the positive electrode P to the negative electrode G. The magnitude of the electric field corresponds to the voltage of a second electric pulse signal CH4 fed from the driver 10d via the variable delay unit 248d to the second period changing unit 242b. The refraction index of a portion (predetermined portion) of the second optical path 24c between the positive electrode P and the negative electrode G changes according to the electric field generated by the second period changing unit 242b. In other words, the change in the refraction index corresponds to the voltage of the second electric pulse signal CH4 fed from the driver 10d via the variable delay unit 248d to the second period changing unit 242b. A period for which the second demultiplexed light passes the second optical path 24c changes according to the change in the refraction index.

It is assumed that the second period changing unit 242b changes the phase of the second demultiplexed light by π when the second electric pulse signal CH4 fed from the driver 10d via the variable delay unit 248d to the second period changing unit 242b is in a predetermined state (when the voltage of the pulse is at the “High” level, for example).

The delay unit 244 delays either one or both of the first demultiplexed light and the second demultiplexed light so that the output of the multiplexing unit 24d is minimized when the first electric pulse signals and the second electric pulse signals are not fed to the optical signal generation device 20. In the example shown in FIG. 2, the delay unit 244 is arranged along the first optical path 24b, and is thus to delay the first demultiplexed light.

Moreover, the delay unit 244 includes the positive electrode P and the negative electrode G. A DC bias which outputs a DC voltage is connected to the positive electrode P. The negative electrode G is grounded. An electric field according to the voltage of the DC bias is generated from the positive electrode P to the negative electrode G. The refraction index of a portion of the first optical path 24b between the positive electrode P and the negative electrode G changes according to this electric field, and the first demultiplexed light is thus delayed. By adjusting the voltage of the DC bias, it is possible to adjust the period of delaying the first demultiplexed light, thereby minimizing the output of the multiplexing unit 24d when the first electric pulse signals and the second electric pulse signals are not fed to the optical signal generation device 20.

In this case, the delay unit 244 causes a difference in phase between the first demultiplexed light and the second demultiplexed light to be π when the first electric pulse signals and the second electric pulse signals are not fed to the optical signal generation device 20.

When the difference in phase between the first demultiplexed light and the second demultiplexed light is zero if the delay unit 244 is not present, and the first electric pulse signals and the second electric pulse signals are not fed to the optical signal generation device 20, the delay unit 244 is to change the phase of the first demultiplexed light by π.

When the difference in phase between the first demultiplexed light and the second demultiplexed light is d if the delay unit 244 is not present, and the first electric pulse signals and the second electric pulse signals are not fed to the optical signal generation device 20, the delay unit 244 is to change the phase of the first demultiplexed light by (π−d).

The delay unit 244 may delay either one or both of the first demultiplexed light and the second demultiplexed light so that the output of the multiplexing unit 24d is maximized when the first electric pulse signals and the second electric pulse signals are not fed to the optical signal generation device 20.

The variable delay unit 248b delays the first electric pulse signal CH3 with respect to the first electric pulse signal CH1. The variable delay unit 248c delays the second electric pulse signal CH2 with respect to the first electric pulse signal CH1. The variable delay unit 248d delays the second electric pulse signal CH4 with respect to the first electric pulse signal CH1.

A description will later be given of the periods of the first electric pulse signal CH3 and the second electric pulse signals CH2 and CH4 respectively delayed by the variable delay units 248b, 248c and 248d with respect to the first electric pulse signal CH1. Moreover, the variable delay units 248b, 248c and 248d can change the delay periods of the first electric pulse signal CH3 and the second electric pulse signals CH2 and CH4 to a value represented by the following equation (1).

It is assumed that the number of the multiple first period changing units 240a and 240b is N1 (N1 is an integer equal to or more than two). It is also assumed that the number of the multiple second period changing units 242a and 242b is N2 (N2 is an integer equal to or more than two). Moreover, N=N1+N2. In the first embodiment, N1=2, N2=2, and N=4.

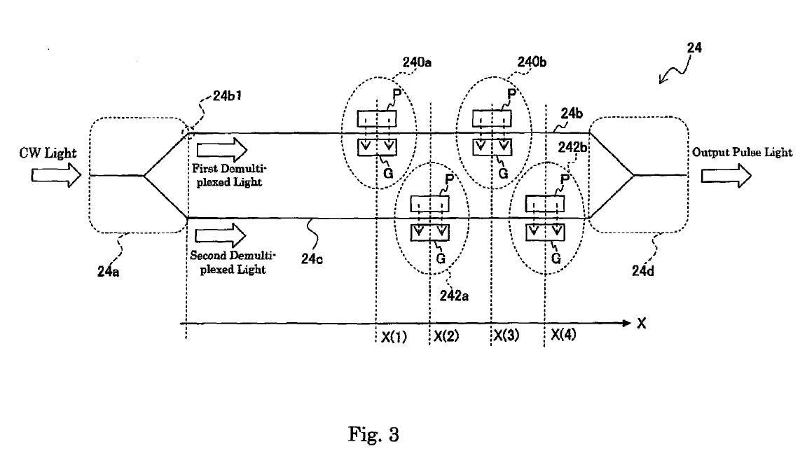

FIG. 3 describes coordinates of the first period changing units 240a and 240b, and the second period changing units 242a and 242b. For the sake of illustration, FIG. 3 shows, out of the optical signal bit rate adjustment device 24, only the demultiplexing unit 24a, the first optical path 24b, the second optical path 24c, the multiplexing unit 24d, the first period changing units 240a and 240b, and the second period changing units 242a and 242b.

An incident end of the first optical path 24b to which the first demultiplexed light is made incident is denoted by 24b1. The incident end 24b1 is considered as a portion at which the demultiplexing unit 24a and the first optical path 24b join to each other. An axis in the direction of the first optical path 24b is denoted by X. The first period changing units 240a and 240b, and the second period changing units 242a and 242b are associated with an integer n equal to or more than 1 and equal to or less than N (=4). As the projections on the axis X of the first period changing units 240a and 240b, and the second period changing units 242a and 242b approach a projection on the axis X of the incident end 24b1, the integer n becomes smaller. When the first period changing units 240a and 240b, and the second period changing units 242a and 242b are projected on the axis X, it is assumed that an arbitrary point (such as the center of gravity) of the first period changing units 240a and 240b, and the second period changing units 242a and 242b are projected on the axis X.

Then, the first period changing units 240a and 240b, and the second period changing units 242a and 242b are respectively associated with n=1, n=3, n=2 and n=4.

When n is equal to or more than two, the first electric pulse signal CH3 fed to the first period changing unit 240b at the coordinate X(n) (n=3), and the second electric pulse signals CH2 and CH4 fed to the second period changing units 242a and 242b at the coordinate X(n) (n=2, 4) correspond to signals obtained by delaying the first electric pulse signal CH1 fed to the first period changing unit 240a at a coordinate X(1) by:

(m/N+k)·PW+(X(n)−X(1))nₒ/C (1)

where C is the velocity of light, k is an arbitrary integer, and m is an integer equal to or more than 1, and equal to or less than N−1. Moreover, respectively for the first period changing unit 240b and the second period changing units 242a and 242b, m takes different values.

When the second period changing unit 242a is arranged so as to correspond to the coordinate X(1) (the projection on the axis X of the second period changing unit 242a is closest to the projection on the axis X of the incident end 24b1), the first electric pulse signals (the second electric pulse signal) fed to the first period changing units (second period changing unit) corresponding to the coordinate X(n) (n=2, 3 and 4) are delayed by the period represented by the equation (1) with respect to the second electric pulse signal fed to the second period changing unit 242a.

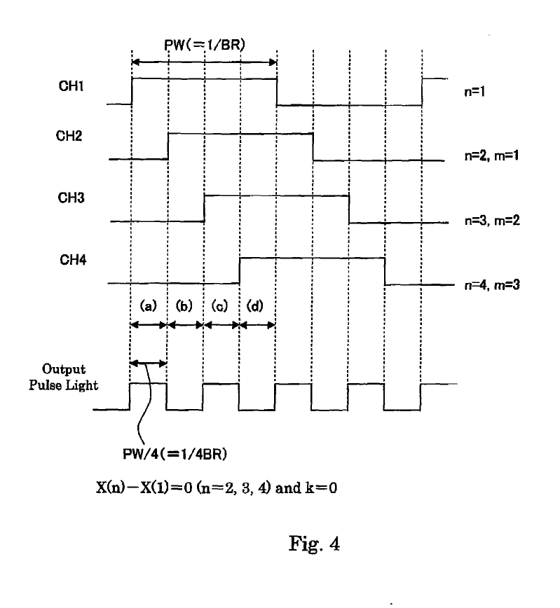

FIG. 4 shows waveforms of the first electric pulse signals CH1 and CH3, the second electric pulse signals CH2 and CH4, and the output pulse light when X(n)−X(1)=0 (n=2, 3, 4), and k=0. Then, X(n)−X(1)=0 and k=0 are assigned to the equation (1), and the delays of the first electric pulse signals CH1 and CH3, and the second electric pulse signals CH2 and CH4 are represented by:

(m/N)·PW (2)

As n decreases, m decreases. In other words, when n=2 (corresponding to the second period changing unit 242a and the second electric pulse signal CH2), m=1. When n=3 (corresponding to the first period changing unit 240b and the first electric pulse signal CH3), m=2. When n=4 (corresponding to the second period changing unit 242b and the second electric pulse signal CH4), m=3. Thus, the waveforms of the first electric pulse signal CH1, the second electric pulse signal CH2, the first electric pulse signal CH3, and the second electric pulse signal CH4 are displaced from each other by PW/4 (=PW/N).

In this case, the pulse width of the output pulse light is PW/4.

A description will now be given of an operation of the first embodiment.

First, while the first electric pulse signals and the second electric pulse signals are not fed to the optical signal generation device 20, the CW light is fed from the continuous wave light source 22 to the demultiplexing unit 24a of the optical signal bit rate adjustment device 24. The CW light is demultiplexed into the first demultiplexed light and the second demultiplexed light, and the first demultiplexed light and the second demultiplexed light pass respectively through the first optical path 24b and the second optical path 24c. The multiplexing unit 24d multiplexes the first demultiplexed light having passed the first optical path 24b and the second demultiplexed light having passed the second optical path 24c, and outputs the output pulse light. The power of the output pulse light is measured by a power measurement device which is not shown.

On this occasion, while the voltage of the DC bias is changing, the power of the output pulse light is measured. The refraction index of the portion of the first optical path 24b between the positive electrode P and the negative electrode G of the delay unit 244 changes according to the voltage of the DC bias, and the first demultiplexed light is thus delayed. As a result, the difference in phase between the first demultiplexed light and the second demultiplexed light changes.

The voltage of the DC bias is adjusted so as to minimize the power of the output pulse light. As a result, the delay unit 244 sets the difference in phase between the first demultiplexed light and the second demultiplexed light to π when the first electric pulse signals and the second electric pulse signals are not fed to the optical signal generation device 20.

Then, the first electric pulse signals and the second electric pulse signals are fed to the optical signal generation device 20, and the CW light is fed from the continuous wave light source 22 to the demultiplexing unit 24a of the optical signal bit rate adjustment device 24. The CW light is demultiplexed into the first demultiplexed light and the second demultiplexed light, and the first demultiplexed light and the second demultiplexed light pass respectively through the first optical path 24b and the second optical path 24c. It should be noted that the first demultiplexed light is delayed by the delay unit 244, the first period changing units 240a and 240b, and the second demultiplexed light is delayed by the second period changing units 242a and 242b. As a result, the difference in phase between the first demultiplexed light and the second demultiplexed light changes. Thus, the waveform of the output pulse light changes as follows.

First, it is assumed that X(n)−X(1)=0 (n=2, 3, 4), and k=0. In this case, the first electric pulse signals CH1 and CH3 and the second electric pulse signals CH2 and CH4 have waveforms as shown in FIG. 4. It should be noted that the width (lengths of period) of sections (a), (b), (c) and (d) is PW/4 in FIG. 4.

In the section (a), the first electric pulse signal CH1 is at the “High” level, and the first electric pulse signal CH3 and the second electric pulse signals CH2 and CH4 are at a “Low” level. On this occasion, the phase of the first demultiplexed light is changed by π by the delay unit 244, and by π by the first period changing unit 240a. Thus, the phase of the first demultiplexed light changes by π+π=2π. This corresponds to no change in phase. The phase of the second demultiplexed light does not change at all. Since the phases of the first demultiplexed light and the second demultiplexed light do not change (the difference in phase between the first demultiplexed light and the second demultiplexed light is zero), and the first demultiplexed light and the second demultiplexed light are multiplexed by the multiplexing unit 24d, the first demultiplexed light and the second demultiplexed light intensify each other, resulting in a “High” level in intensity of the output (output pulse light) of the multiplexing unit 24d.

In the section (b), the first electric pulse signal CH1 and the second electric pulse signal CH2 are at the “High” level, and the first electric pulse signals CH3 and CH4 are at the “Low” level. On this occasion, the phase of the first demultiplexed light is changed by the delay unit 244 by π, and by the first period changing unit 240a by π. Thus, the phase of the first demultiplexed light changes by π+π=2π. This corresponds to no change in phase. The phase of the second demultiplexed light is changed by the second period changing unit 242a by π. Since the difference in phase between the first demultiplexed light and the second demultiplexed light is π, and the first demultiplexed light and the second demultiplexed light are multiplexed by the multiplexing unit 24d, the first demultiplexed light and the second demultiplexed light attenuate each other, resulting in a “Low” level in intensity of the output (output pulse light) of the multiplexing unit 24d.

In the section (c), the first electric pulse signals CH1 and CH3, and the second electric pulse signal CH2 are at the “High” level, and the first electric pulse signal CH4 is at the “Low” level. On this occasion, the phase of the first demultiplexed light is changed by the delay unit 244 by π, by the first period changing unit 240a by π, and by the first period changing unit 240b by π. Thus, the phase of the first demultiplexed light changes by π+π+π=3π. This corresponds to a change by π in phase. The phase of the second demultiplexed light is changed by the second period changing unit 242a by π. Since the difference in phase between the first demultiplexed light and the second demultiplexed light is zero, and the first demultiplexed light and the second demultiplexed light are multiplexed by the multiplexing unit 24d, the first demultiplexed light and the second demultiplexed light intensify each other, resulting in the “High” level in intensity of the output (output pulse light) of the multiplexing unit 24d.

In the section (d), the first electric pulse signals CH1 and CH3, and the second electric pulse signals CH2 and CH4 are at the “High” level. On this occasion, the phase of the first demultiplexed light is changed by the delay unit 244 by π, by the first period changing unit 240a by π, and by the first period changing unit 240b by π. Thus, the phase of the first demultiplexed light changes by π+π+π=3π. This corresponds to a change by π in phase. The phase of the second demultiplexed light is changed by the second period changing unit 242a by π, and by the second period changing unit 242b by π. Thus, the phase of the second demultiplexed light changes by π+π=2π. This corresponds to no change in phase. Since the difference in phase between the first demultiplexed light and the second demultiplexed light is π, and the first demultiplexed light and the second demultiplexed light are multiplexed by the multiplexing unit 24d, the first demultiplexed light and the second demultiplexed light attenuate each other, resulting in the “Low” level in intensity of the output (output pulse light) of the multiplexing unit 24d.

In this way, the output pulse light forms pulses with the pulse width of PW/4. Thus, the bit rate of the output pulse light is the reciprocal of PW/4, namely 4BR. When the bit rate BR of the first electric pulse signal and the second electric pulse signal is 5 Gbps, the bit rate of the output pulse light is 5 Gbps×4=20 Gbps.

Though it is assumed that as n decreases, m decreases in FIG. 4, the relationship of n and m is not limited to this case. It is only necessary that, respectively for the first period changing unit 240b and the second period changing units 242a and 242b, m takes different values. For example, there may be a case when n=2, m=3, when n=3, m=2, and when n=4, m=1.

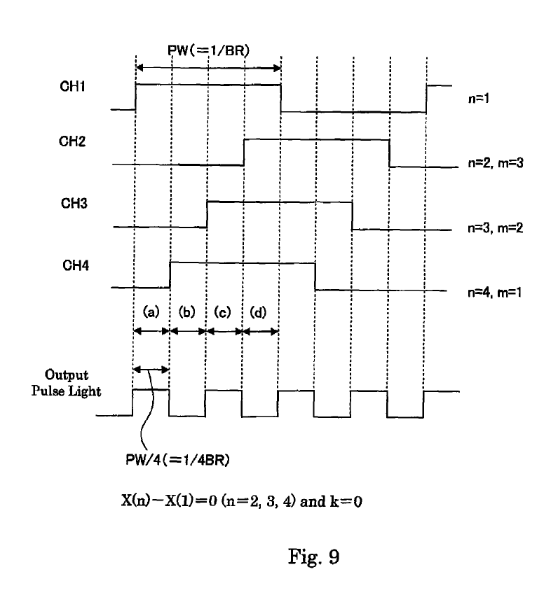

FIG. 9 shows waveforms of the first electric pulse signals CH1 and CH3, the second electric pulse signals CH2 and CH4, and the output pulse light in this variation (when n=2, m=3, when n=3, m=2, and when n=4, m=1). In the case shown in FIG. 9, when X(n)−X(1)=0 (n=2, 3, 4), and k=0, the waveform of the second electric pulse signal CH2 and the waveform of the second electric pulse signal CH4 shown in FIG. 4 are switched. Even in this case, the waveform of the output pulse light is the same as that shown in FIG. 4.

Moreover, though it is assumed that k=0 in FIG. 4, k may be an arbitrary integer, and k may take a different value for a different value of n. For example, when n=2, k=1, and when n=3 and 4, k=0.

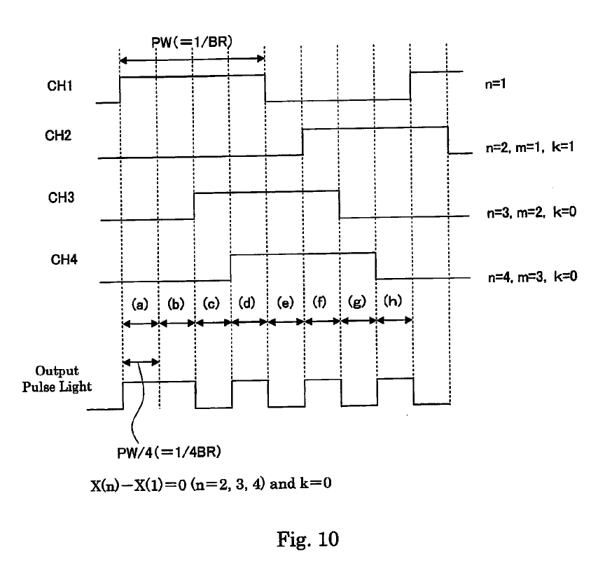

FIG. 10 shows waveforms of the first electric pulse signals CH1 and CH3, the second electric pulse signals CH2 and CH4, and the output pulse light in this variation (when n=2, k=1, and when n=3 and 4, k=0). In the case shown in FIG. 10, when X(n)−X(1)=0 (n=2, 3, 4), as in FIG. 4, the output pulse is at the “High” level in the section (a), and the level of the output pulse is “High”, “Low” and “High” respectively in the sections (b), (c) and (d). In the sections (e), (f), (g) and (h) (width: PW/4) following the section (d), the level of the output pulse is “Low”, “High”, “Low” and “High”, respectively.

As shown in FIG. 10, by properly setting the value of k, it is possible to change the waveform of the output pulse light while the bit rate of the output pulse light is kept to 4BR. For example, referring to the sections (a) and (b), the “High” level can be continued.

Moreover, the expression X(n)−X(1)>0 is actually given for n=2, 3 and 4 as shown in FIG. 3. Then, periods after the first demultiplexed light reaches the point corresponding to the coordinate X(1) on the first optical path 24b until it reaches the points respectively corresponding to the coordinates X(2), X(3) and X(4) are not negligible.

Thus, actually, unless the second electric pulse signal CH2 is delayed by (X(2)−X(1))nₒ/C with respect to the first electric pulse signal CH1 further than the case shown in FIG. 4 (namely, a period after the first demultiplexed light reaches the point corresponding to the coordinate X(1) on the first optical path 24b until it reaches the point corresponding to the coordinate X(2)), the output pulse light having the waveform shown in FIG. 4 cannot be obtained.

Similarly, unless the first electric pulse signal CH3 is delayed by (X(3)−X(1))nₒ/C with respect to the first electric pulse signal CH1 further than the case shown in FIG. 4 (namely, a period after the first demultiplexed light reaches the point corresponding to the coordinate X(1) on the first optical path 24b until it reaches the point corresponding to the coordinate X(3)), the output pulse light having the waveform shown in FIG. 4 cannot be obtained.

Similarly, unless the second electric pulse signal CH4 is delayed by (X(4)−X(1))nₒ/C with respect to the first electric pulse signal CH1 further than the case shown in FIG. 4 (namely, a period after the first demultiplexed light reaches the point corresponding to the coordinate X(1) on the first optical path 24b until it reaches the point corresponding to the coordinate X(4)), the output pulse light having the waveform shown in FIG. 4 cannot be obtained.

Thus, the first electric pulse signal CH3 fed to the first period changing unit 240b at the coordinate X(n) (n=3), and the second electric pulse signals CH2 and CH4 fed to the second period changing units 242a and 242b at the coordinate X(n) (n=2, 4) correspond to signals obtained by delaying the first electric pulse signal CH1 fed to the first period changing unit 240a at the coordinate X(1) by the period represented by the equation (1).

The output pulse light output from the multiplexing unit 24d is fed to the output pulse light adjustment unit 26. The output pulse light adjustment unit 26 adjusts the height or the offset of the output pulse light output by the multiplexing unit 24d of the optical signal bit rate adjustment device 24, thereby outputting the optical test signal. The optical test signal is fed to the DUT 2.

According to the first embodiment, it is possible to obtain the output pulse light at a bit rate (such as 20 Gbps) higher than the bit rate BR (such as 5 Gbps) of the first electric pulse signal and the second electric pulse signal. In other words, the bit rate of the output pulse light can be properly adjusted.

### Second Embodiment

The optical signal generation device 20 according to the second embodiment is obtained by changing the continuous wave light source 22 of the optical signal generation device 20 according to the first embodiment to a pulse light source 23, and, accordingly, providing an NRZ conversion unit 25 and an NRZ pulse light adjustment unit 27.

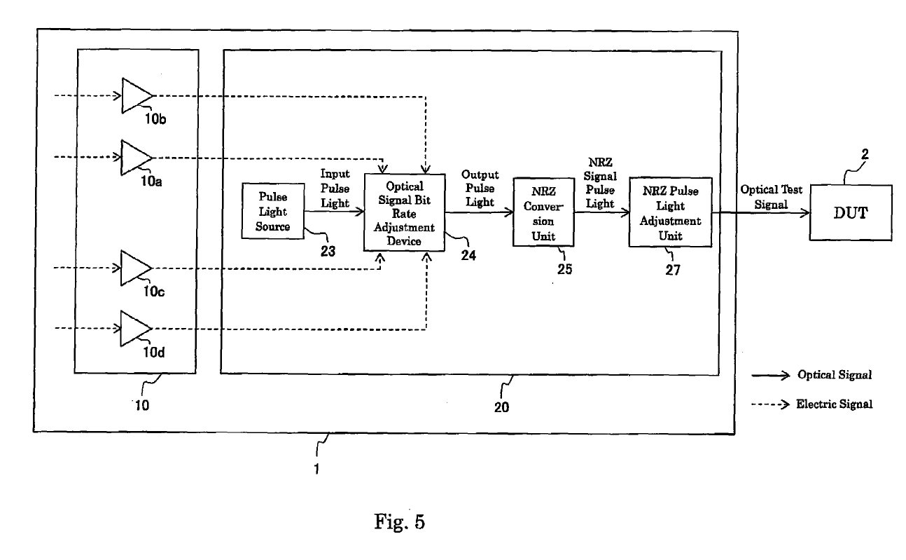

FIG. 5 is a block diagram showing the configuration of the optical test device 1 according to the second embodiment of the present invention. The optical test device 1 according to the second embodiment includes the driver module (electric pulse signal source) 10 and the optical signal generation device 20. In the following section, the same components are denoted by the same numerals as of the first embodiment, and will be explained in no more details. The driver module 10 is the same as that of the first embodiment, and a description thereof is, therefore, omitted.

The optical signal generation device 20 includes the pulse light source 23, the optical signal bit rate adjustment device 24, the NRZ conversion unit 25, and the NRZ pulse light adjustment unit 27.

The pulse light source 23 provides the demultiplexing unit 24a with input pulse light.

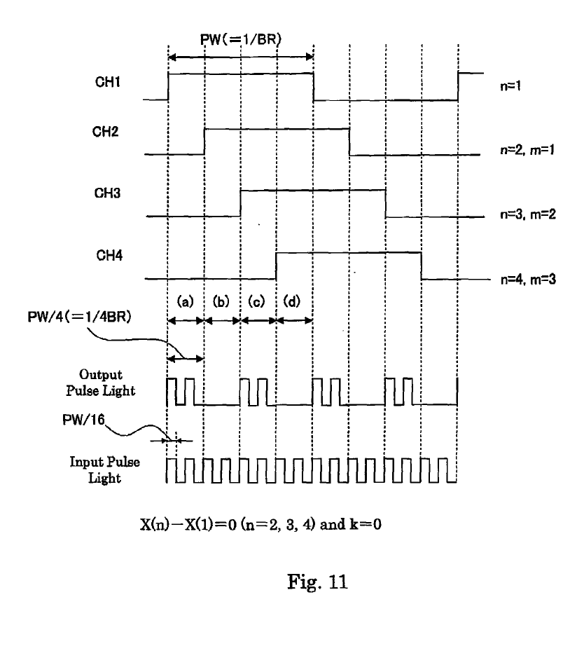

The optical signal bit rate adjustment device 24 is the same as that in the first embodiment, and a description thereof, therefore, is omitted. However, a description will be given of the waveform of the output pulse light with reference to FIG. 11. FIG. 11 shows waveforms of the first electric pulse signals CH1 and CH3, the second electric pulse signals CH2 and CH4, and the output pulse light when X(n)−X(1)=0 (n=2, 3, 4), and k=0 according to the second embodiment.

The waveforms of the first electric pulse signals CH1 and CH3, and the second electric pulse signals CH2 and CH4 are the same as those of the first embodiment, and a description thereof is omitted. It should be noted that the input pulse light is fed to the demultiplexing unit 24a, and it is assumed the pulse width thereof is PW/16. Then, the waveform of the output pulse light which is supposed to present the “High” level (refer to FIG. 4), presents the “High”, “Low”, “High” and “Low” levels in the sections (a) and (c). In this way, the waveform of the output pulse light in the sections (a) and (c) returns from the “High” level to the “Low” level, and then rises again to the “High” level. In other words, the output pulse light is an RZ (return-to-zero) signal.

The NRZ conversion unit 25 converts the output pulse light output from the multiplexing unit 24d, which is an RZ signal, to an NRZ (non-return-to-zero)-signal pulse light. A method for converting the RZ signal light to the NRZ signal light is widely know, and a description thereof is omitted. The NRZ signal pulse light does not return from the “High” level to the “Low” level in the sections (a) and (c), and remains at the “High” level.

The NRZ pulse light adjustment unit 27 adjusts the height or the offset of the NRZ signal, thereby outputting the optical test signal. The NRZ pulse light adjustment unit 27 is configured similarly to the output pulse light adjustment unit 26.

It is assumed that the DUT 2 is suited to light in the form of NRZ signal, and is not suited to light in the form of the RZ signal.

An operation of the second embodiment is the same as that of the first embodiment. However, the second embodiment is different from the first embodiment in that the waveform of the output pulse light is in the form of the RZ signal (refer to FIG. 11), and the output pulse light is converted into the NRZ-signal pulse light by the NRZ conversion unit 25.

According to the second embodiment, there are obtained the same effects as in the first embodiment. However, it is possible to increase timing precision by using the pulse light source 23.

When the DUT 2 is suited to light in the form of the RZ signal, the NRZ conversion unit 25 may be omitted. In this case, the NRZ pulse light adjustment unit 27 is configured to adjust the height or the offset of the output pulse light in the form of the RZ signal.

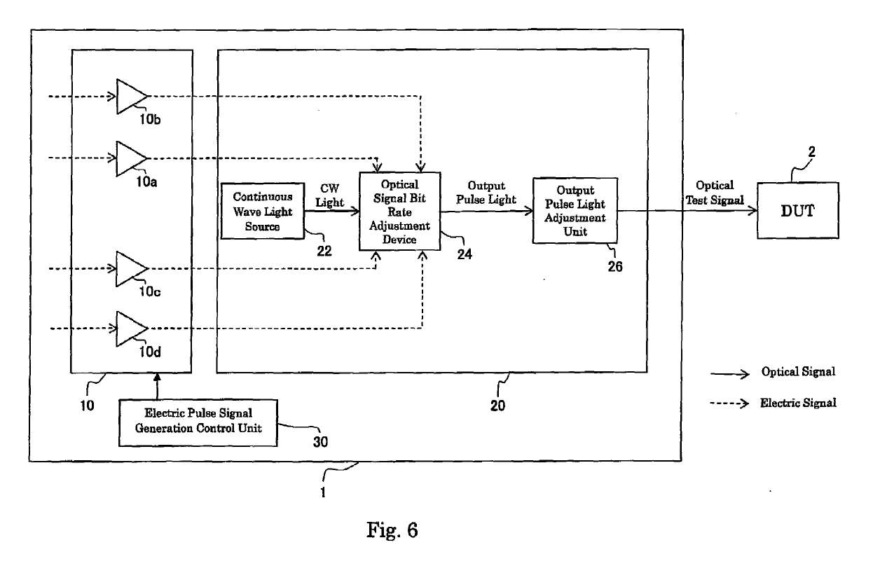

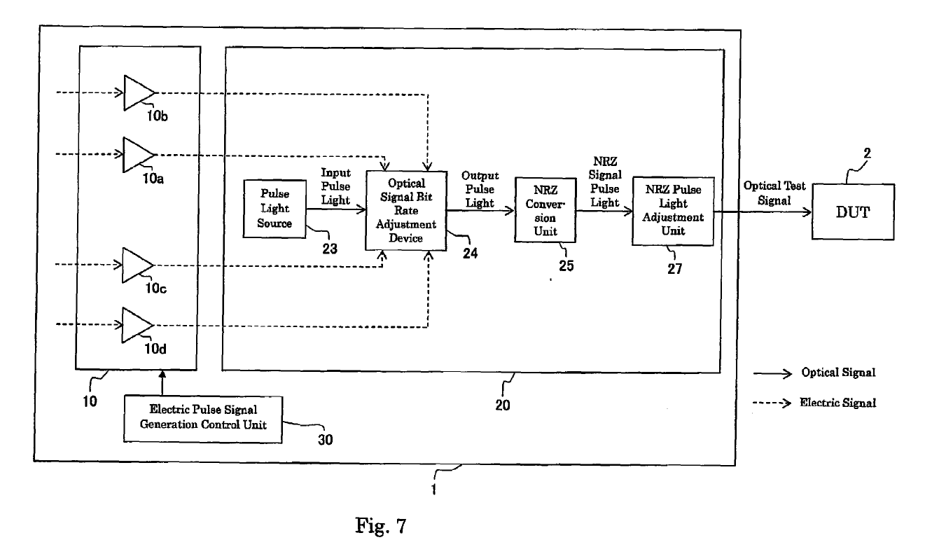

It should be noted that FIG. 6 shows a configuration in which, to the first embodiment, an electric pulse signal generation control unit 30 which controls the driver module 10 of the optical test device 1 according to the first embodiment is added, and FIG. 7 shows a configuration in which, to the second embodiment, the electric pulse signal generation control unit 30 which controls the driver module 10 of the optical test device 1 according to the second embodiment is added.

In FIGS. 6 and 7, the electric pulse signal generation control unit 30 controls the driver module 10 so that the driver module 10 generates the first electric pulse signals and the second electric pulse signals which have the common pulse width PW, and the same phase.

A computer is provided with a CPU, a hard disk, and a media (such as a floppy disk (registered trade mark) and a CD-ROM) reader, and the media reader is caused to read a medium recording a program realizing the electric pulse signal generation control unit 30, thereby installing the program on the hard disk. This method may also realize the functions of the electric pulse signal generation control unit 30.

1. An optical signal bit rate adjustment device comprising:
a demultiplexing unit that demultiplexes a light into a first demultiplexed light and a second demultiplexed light;
a first optical path through which the first demultiplexed light passes;
a second optical path through which the second demultiplexed light passes;
a multiplexing unit that multiplexes the first demultiplexed light which has passed the first optical path and the second demultiplexed light which has passed the second optical path;
a plurality of first period changing units that are disposed along the first optical path, and change a period for which the first demultiplexed light passes through the first optical path according to first electric pulse signals to be fed; and
a plurality of second period changing units that are disposed along the second optical path, and change a period for which the second demultiplexed light passes through the second optical path according to second electric pulse signals to be fed, wherein:
the first electric pulse signals and the second electric pulse signals have a common pulse width PW;
the number of the plurality of first period changing units is N1, where N1 is an integer equal to or more than two;
the number of the plurality of second period changing units is N2, where N2 is an integer equal to or more than two;
N=N1+N2;
X(n) is a coordinate on an axis of the first period changing unit and the second period changing unit in a direction of the first optical path, where n is an integer equal to or more than one and equal to or less than N, and becomes smaller as a projection on the axis of the first period changing unit and the second period changing unit approaches a projection on the axis of an incident end of the first optical path to which the first demultiplexed light is made incident;
for n equal to or more than two, the first electric pulse signal fed to the first period changing unit at a coordinate X(n) and the second electric pulse signal fed to the second period changing unit at the coordinate X(n) correspond to the first electric pulse signal or the second electric pulse signal fed to the first period changing unit or the second period changing unit at a coordinate X(1) delayed by:
(m/N+k)·PW+(X(n)−X(1))nₒ/C
where nₒ is the effective refractive index of the first optical path and the second optical path, C is the velocity of light, k is an arbitrary integer, and m is an integer equal to or more than one and equal to or less than N−1; and
m takes different values respectively for the first period changing units and the second period changing units.

2. The optical signal bit rate adjustment device according to claim 1, wherein as n decreases, m decreases.

3. The optical signal bit rate adjustment device according to claim 1, wherein:
the first period changing unit changes the refraction index at a predetermined portion of the first optical path according to the voltage of the first electric pulse signal to be fed; and
the second period changing unit changes the refraction index at a predetermined portion of the second optical path according to the voltage of the second electric pulse signal to be fed.

4. The optical signal bit rate adjustment device according to claim 1, wherein:
the first period changing unit changes the phase of the first demultiplexed light by π when the first electric pulse signal is in a predetermined state; and
the second period changing unit changes the phase of the second demultiplexed light by π when the second electric pulse signal is in a predetermined state.

5. The optical signal bit rate adjustment device according to claim 1, comprising a delay unit that delays either one of or both of the first demultiplexed light and the second demultiplexed light so as to maximize or minimize an output of the multiplexing unit when the first electric pulse signals and the second electric pulse signals are not fed.

6. An optical signal generation device comprising:
the optical signal bit rate adjustment device according to claim 1; and
a continuous wave light source that supplies the demultiplexing unit with continuous wave light.

7. The optical signal generation device according to claim 6, comprising an output pulse light adjustment unit that adjusts a height or an offset of an output pulse light output by the multiplexing unit.

8. An optical signal generation device comprising:
the optical signal bit rate adjustment device according to claim 1; and
a pulse light source that supplies the demultiplexing unit with input pulse light.

9. The optical signal generation device according to claim 8, comprising:
an NRZ conversion unit that converts output pulse light output by the multiplexing unit into NRZ-signal pulse light; and
an NRZ pulse light adjustment unit that adjusts a height or an offset of the NRZ-signal pulse light.

10. An optical test device comprising:
the optical signal generation device according to claim 6; and
an electric pulse signal source that generates the first electric pulse signal and the second electric pulse signal,
wherein an output of the optical signal generation device is fed to a device under test.

11. An optical signal bit rate adjustment method in an optical signal bit rate adjustment device which comprises a demultiplexing unit that demultiplexes a light into a first demultiplexed light and a second demultiplexed light, a first optical path through which the first demultiplexed light passes, a second optical path through which the second demultiplexed light passes, and a multiplexing unit which multiplexes the first demultiplexed light which has passed the first optical path and the second demultiplexed light which has passed the second optical path, comprising:
causing a plurality of first period changing units that are disposed along the first optical path to change a period for which the first demultiplexed light passes through the first optical path according to a first electric pulse signal to be fed; and
causing a plurality of second period changing units that are disposed along the second optical path to change a period for which the second demultiplexed light passes through the second optical path according to a second electric pulse signal to be fed, wherein:
the first electric pulse signals and the second electric pulse signals have a common pulse width PW;
the number of the plurality of first period changing units is N1, where N1 is an integer equal to or more than two;
the number of the plurality of second period changing units is N2, where N2 is an integer equal to or more than two;
N=N1+N2;
X(n) is a coordinate on an axis of the first period changing unit and the second period changing unit in a direction of the first optical path, where n is an integer equal to or more than one and equal to or less than N, and becomes smaller as a projection on the axis of the first period changing unit and the second period changing unit approaches a projection on the axis of an incident end of the first optical path to which the first demultiplexed light is made incident,
for n equal to or more than two, the first electric pulse signal fed to the first period changing unit at a coordinate X(n) and the second electric pulse signal fed to the second period changing unit at the coordinate X(n) correspond to the first electric pulse signal or the second electric pulse signal fed to the first period changing unit or the second period changing unit at a coordinate X(1) delayed by:
(m/N+k)·PW+(X(n)−X(1))nₒ/C
where nₒ is the effective refractive index of the first optical path and the second optical path, C is the velocity of light, k is an arbitrary integer, and m is an integer equal to more than one and equal to or less than N−1; and
m takes different values respectively for the first period changing units and the second period changing units.

12. (canceled)

13. A computer-readable recording medium recording a program causing a computer to execute electric pulse signal generation control processing for controlling the electric pulse signal source of the optical test device according to claim 10, thereby generating the first electric pulse signal and the second electric pulse signal.
